(19) United States
(12) Patent Application Publication
(10) Pub. No.: US 2010/0046353 A1
(43) Pub. Date: Feb. 25, 2010

(54) OPTICAL RECORDING MEDIUM, OPTICAL HEAD DEVICE AND OPTICAL INFORMATION RECORDING/REPRODUCING DEVICE

(75) Inventor: Ryuichi Katayama, Tokyo (JP)

Correspondence Address: YOUNG & THOMPSON, 209 Madison Street, Suite 500, Alexandria, VA, 22314, US

(73) Assignee: NEC CORPORATION, Tokyo (JP)

(21) Appl. No.: 12/596,936

(22) PCT Filed: Apr. 8, 2008
(86) PCT No.: PCT/JP2008/056934

§ 371 Date: Oct. 21, 2009

(30) Foreign Application Priority Data
Apr. 25, 2007 (JP) 2007-116228

(51) Int. Cl. G11B 7/24

(52) U.S. Cl. 369/275.1; G9B/7

(57) ABSTRACT

Light output from a laser is split into a first beam which is reflected light and a second beam which is transmitted light, by a polarization beam splitter. The polarization directions of the first beam and the second beam are orthogonal to each other. A disk includes a recording layer, a quarter wavelength plate layer, and a reflective layer. When information is recorded on the disk, the first beam, which travels inside the recording layer to the side of the reflective layer, and the second beam, which passes through the recording layer and is reflected at the reflective layer and travels inside the recording layer to the side opposite to the reflective layer, are focused on the same position. When information is reproduced from the disk, the second beam is blocked by a shutter, and the first beam reflected at the recording layer is received by a photodetector.

### TECHNICAL FIELD

The present invention relates to an optical head device for three-dimensionally performing recording and reproducing of information on an optical recording medium.

### BACKGROUND ART

As a technique for realizing a high-capacity optical recording medium, a three-dimensional recording/reproducing technique for three-dimensionally performing recording and reproducing of information on an optical recording medium, using not only an in-plane direction of the optical recording medium but also a thickness direction, has been known. As an example of the three-dimensional recording/reproducing technique, there is one in which opposing two beams are focused on the same position so as to be interfered with each other within a recording layer of an optical recording medium, information is recorded by forming a minute diffraction grating near the focal point, one of the two beams is focused on the diffraction grating, and information is reproduced by receiving a reflected light from the diffraction grating.

In this technique, by using a reflection-type optical recording medium having a recording layer and a reflective layer, an optical system of an optical head device for performing recording/reproducing of information on the optical recording medium can be simple by being concentrated on one side of the optical recording medium. Non-Patent Document 1 discloses an optical head device for performing three-dimensional recording and reproducing on such a reflection-type optical recording medium.

FIG. 10 shows an optical path diagram of the optical head device described in Non-Patent Document 1. Hereinafter, description will be given based on FIG. 10. In the below description, an “optical head device” and an “optical disk” indicated with reference numerals will be abbreviated as an “optical head” and a “disk”.

In an optical head 110, light emitted from a laser 63 passes through an expander lens system consisting of a concave lens 64 and a convex lens 65, so that the beam diameter is expanded, and a part thereof is reflected at a beam splitter 66 and passes through a half wavelength plate 67 whereby the polarization direction becomes a predetermined direction, and a part thereof passes through a polarization beam splitter 68 as a P-polarized component, and a part thereof is reflected at the polarization beam splitter 68 as an S-polarized component.

When information is recorded on a disk 62, light passing through the polarization beam splitter 68 is reflected at a mirror 69, passes through a quarter wavelength plate 73 and then is converted to circular polarized light, passes through a relay lens system consisting of convex lenses 75 and 76 so as to be convergent light. A part thereof is reflected at a beam splitter 80 and is focused inside a recording layer of a disk 62 by an objective lens 81. On the other hand, the light reflected at the polarization beam splitter 68 passes through a half wavelength plate 70 and so the polarization direction is rotated by 90°, passes through a shutter 71, enters the polarization beam splitter 72 as P-polarized light and almost 100% thereof passes therethrough, passes through a quarter wavelength plate 74 to thereby be converted from linear polarized light to circular polarized light, and then passes through a relay lens system consisting of a convex lenses 77 and 78 to thereby become divergent light. A part thereof is reflected at a beam splitter 79, and a part thereof passes through a beam splitter 80, to be focused inside the recording layer of the disk 62 by the objective lens 81.

In contrast, when information is reproduced from the disk 62, although a part of a light beam passing through the polarization beam splitter 68 is focused inside the recording layer of the disk 62, the light reflected at the polarization beam splitter 68 is blocked by a shutter 7 and does not travel to the disk 62. The light focused inside the recording layer of the disk 62 is reflected at the recording layer of the disk 62, and passes through the objective lens 81 in an opposite direction. A part thereof is reflected at the beam splitter 80, passes through the relay lens system consisting of the convex lenses 76 and 75 in an opposite direction, passes through the quarter wavelength plate 73 and is converted from the circular polarized light to linear polarized light in which the outward direction and the polarization direction are orthogonal to each other. The light is reflected at the mirror 69, enters the polarization beam splitter 68 as S-polarized light and almost 100% thereof is reflected, and is focused on the light receiving section of a photodetector 83 by a convex lens 82.

FIGS. 11 to 13 are optical path diagrams showing incident beams and reflected beams with respect to the optical disk of FIG. 10. Hereinafter, description will be given based on FIGS. 10 to 13.

The disk 62 is configured such that a recording layer 86 and a reflective layer 87 are sandwiched in this order between substrates 84 and 85. Light enters from the side of the recording layer 86 through the substrate 84. FIGS. 11 and 12 show optical paths of incident beams and reflected beams when information is recorded on the disk 62. An incident beam 89 in FIG. 11 and an incident beam 91 in FIG. 12 respectively correspond to light passing through the polarization beam splitter 68 and light reflected at the polarization beam splitter 68 in FIG. 10. Meanwhile, FIG. 13 shows optical paths of an incident beam and a reflected beam when information is reproduced from the disk 62. An incident beam 93 in FIG. 13 corresponds to light passing through the polarization beam splitter 68 in FIG. 10.

In FIG. 11, the incident beam 89 enters the objective lens 81 as convergent light, and is focused on the way to the side of the reflective layer 87 within the recording layer 86. This light is reflected at the reflective layer 89 so as to be a reflected beam 90 which passes through the recording layer 86 and is output from the objective lens 81 as convergent light. On the other hand, in FIG. 12, the incident beam 91 enters the objective lens 81 as divergent light which passes through the recording layer 86 and is reflected at the reflective layer 87 so as to be a reflected beam 92 and is focused on the way to the side opposite the reflective layer 87 within the recording layer 86. This light is output from the objective lens 81 as divergent light. The incident beam 89 and the reflected beam 92 are focused on the same position in the recording layer 86 and are interfered with each other, whereby a minute diffraction grating is formed near the focal point.

On the other hand, in FIG. 13, the incident beam 93 enters the objective lens 81 as convergent light, and is focused on the diffraction grating 88 on the way to the side of the reflective layer 87 within the recording layer 86. This light is reflected at the diffraction grating 88 so as to be a reflected beam 94, and is output from the objective lens 81 as divergent light. The reflected beam 94 is received by the photodetector 83 shown in FIG. 10. In this case, the diffraction grating 88 corresponds to a recording mark. The position of the focal point of the incident beam 89 and the reflected beam 92 is moved toward a thickness direction of the recording layer 86 so as to form a plurality of diffraction gratings not only in the in-plane direction of the recording layer 86 but also in the thickness direction thereof, whereby three-dimensional recording/reproducing can be performed.

It should be noted that the optical head 110 is provided with a mirror 111, convex lenses 112 and 113, cylindrical lenses 114 and 115, and photodetectors 116 and 117, and the like, for tracking servo and for focus servo.

Non-Patent Document 1: 2006 Optical Data Storage Topical Meeting Conference Proceedings, pp. 188-190

### DISCLOSURE OF THE INVENTION

### Problems to be Solved by the Invention

In the optical head device described in Non-Patent Document 1, the diffraction grating 88 is formed by interference between the incident beam 89 and the reflected beam 92. The incident beam 89 and the reflected beam 92 are focused on the same position in the recording layer 86, and as the intensity per unit area of the incident beam 89 and the reflected beam 92 near the focal point is high, diffraction efficiency near the focal point of the diffraction grating 88 is high. It should be noted that besides the diffraction grating 88, a diffraction grating is formed by each of interference between the incident beam 89 and the reflected beam 90, interference between the incident beam 91 and the reflected beam 92, interference between the incident beams 89 and 91, interference between the reflected beam 90 and 92, and interference between the incident beam 91 and the reflected beam 90.

Among them, as the incident beam 91 and the reflected beam 90 are not focused inside the recording layer 86, the intensity per user area of the incident beam 91 and the reflected beam 90 is low. As such, diffraction efficiency formed by interference between the incident beam 91 and the reflected beam 90 is very low. However, diffraction efficiency near the focal point of the incident beam 89 of the diffraction grating formed by interference between the incident beam 89 and the reflected beam 90, diffraction efficiency near the focal point of the reflected beam 92 of the diffraction grating formed by interference between the incident beam 91 and the reflected beam 92, diffraction efficiency near the focal point of the incident beam 89 of the diffraction grating formed by interference between the incident beams 89 and 91, and diffraction efficiency near the focal point of the reflected beam 92 of the diffraction grating formed by interference between the reflected beams 90 and 92, are not so low. This means that besides the diffraction grating 88 of high diffraction efficiency, four diffraction gratins, in which the diffraction efficiencies thereof are not so low, are formed in an overlapping manner near the focal point of the incident beam 89 and the reflected beam 92.

When the incident beam 93 is made incident on the objective lens 81 as convergent light, a reflected beam to be output from the objective lens 81 as convergent light is generated, by the diffraction grating formed by interference between the incident beam 89 and the reflected beam 90 and by the diffraction grating formed by interference between the incident beam 91 and the reflected beam 92. As the generated reflected beam is wide at the position of the photodetector 83, it is not received by the photodetector 83. On the other hand, when the incident beam 93 is made incident on the objective lens 81 as convergent light, a reflected beam to be output from the objective lens 81 as divergent light is generated, by the diffraction grating formed by interference between the incident beams 89 and 91 and by the diffraction grating formed by interference between the reflected beams 90 and 92. The generated reflected beam is received by the photodetector 83, as the reflected beam 94.

Although the diffraction grating 88 is a reflective diffraction grating in which the grating direction is an in-plane direction of the recording layer 86, the diffraction grating formed by interference between the incident beams 89 and 91 and the diffraction grating formed by interference between the reflected beams 90 and 92 are transmission-type diffraction gratings in which the grating direction is a thickness direction of the recording layer 86. In this case, when the temperature of the recording layer 86 changes, the recording layer 86 expands or contracts, so that the grating intervals in the diffraction grating change. As the degrees of expansion or contraction of the recording layer 86 differ in the in-plane direction and in the thickness direction, the degrees of change in the grating intervals in the diffraction grating differ in the reflection-type diffraction grating and in the transmission-type diffraction grating. In this case, in the reflected beams generated by the diffraction grating formed by interference between the incident beams 89 and 91 and generated by the diffraction grating formed by interference between the reflected beams 90 and 92, the degree of divergence changes with respect to the reflected beam 94. As a result, if the reflected beam 94 is focused on the light receiving section of the photodetector 83, the reflected beams generated by the diffraction grating formed by interference between the incident beams 89 and 91 and by the diffraction grating formed by interference between the reflected beams 90 and 92 expand at the position of the photodetector 83, and are not received by the photodetector 83.

In other words, when changes in the temperature of the recording layer 86 are considered, four diffraction gratings other than the diffraction grating 88 formed near the focal point of the incident beam 89 and the reflected beam 92 are diffraction gratins not contributing to readout of the information. When diffraction gratins not contributing to readout of the information are formed as described above, diffraction efficiency of the diffraction grating 88 contributing to readout of the information becomes lowered accordingly, whereby the quality of a readout signal is deteriorated.

It is an object of the present invention is to provide an optical head device capable of solving the problems described above involved in optical head devices and the like for three-dimensionally performing recording and reproducing of information on an optical recording medium, capable of preventing formation of diffraction gratings not contributing to readout of information within the recording layer of an optical recording medium, and capable of realizing high-quality readout signals.

### Means for Solving the Problems

In order to achieve the object, an optical recording medium according to the present invention is an optical recording medium including a recording layer and a reflective layer, in which a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer. The optical recording medium includes a quarter wavelength plate layer provided between the recording layer and the reflective layer, for acting as a quarter wavelength plate with respect to the first beam and the second beam.

An optical head device according to the present invention is an optical head device for use of an optical recording medium. The optical recoding medium includes a recording layer and a reflective layer, in which a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer, and the optical recording medium includes a quarter wavelength plate layer provided between the recording layer and the reflective layer, for acting as a quarter wavelength plate with respect to the first beam and the second beam. The optical head device includes a beam generation unit which generates the first beam and the second beam, a lens system which focuses the first beam and the second beam on the same position in the recording layer, and a polarization setting unit which differentiates the polarization states of the first beam and the second beam entering the optical recording medium.

An optical information recording/reproducing device according to the present invention includes an optical head device and a beam block driving unit which drives a beam blocking unit such that the beam blocking unit does not block the first beam and the second beam when information is recorded on the optical recording medium and blocks one of the first beam and the second beam when information is reproduced from the optical recording medium. The optical head device includes the beam blocking unit capable of switching whether or not to block one of the first beam and the second beam entering the optical recording medium, and a photodetector which receives reflected light from the diffraction grating by another one of the first beam and the second beam which is not blocked by the beam blocking unit.

### Effects of the Invention

As described above, according to the present invention, a high-quality readout signal can be obtained when recording and reproducing of information are performed three-dimensionally on an optical recording medium. This is because a diffraction grating not contributing to readout of information will not be generated within the recording layer of the optical recording medium.

### BEST MODES FOR CARRYING OUT THE INVENTION

Hereinafter, exemplary embodiment of the invention will be described in detail based on the drawings.

FIG. 1 is an optical path diagram showing a first exemplary embodiment of an optical head device according to the present invention. Hereinafter, description will be given based on FIG. 1.

An optical head 1 of the exemplary embodiment is characterized as to include a beam generation unit (polarization beam splitter 7) which generates a first beam and a second beam, a lens system (from a mirror 8 to an objective lens 18 and from a beam splitter 11 to the objective lens 18) which focuses the first beam and the second beam on the same position in the recording layer of a disk 2, a polarization setting unit (polarization beam splitter 7) which differentiates polarization states of the first beam and the second beam entering the disk 2, a beam blocking unit (shutter 9) capable of switching whether or not to block one of the first beam and the second beam entering the disk 2, and a photodetector 20 which receives reflected light from the recording layer of the disk 2 by the other one of the first beam and the second beam which was not blocked by the beam blocking unit. Detailed description will be given below.

In the optical head 1, a laser 3 serving as a light source is a single-mode semiconductor layer of an external resonator type in which a diffraction grating is used as an external resonator, and outputs light having a wavelength of 405 nm. Light output from the laser 3 passes through an expander lens system formed of a concave lens 4 and a convex lens 5 so that the beam diameter thereof is expanded. The light passes through a half wavelength plate 6 whereby the polarization direction becomes a direction of 45° relative to the sheet, and about 50% thereof is reflected as an S-polarized component at the polarization beam splitter 7 and about 50% thereof passes through the polarization beam splitter 7 as a P-polarized component. It should be noted that the light reflected at the polarized beam splitter 7 and the light passing through the beam splitter 7 respectively correspond to the first beam and the second beam, and the polarization beam splitter 7 corresponds to a unit serving as both the beam generation unit and the polarization setting unit.

When information is recorded on the disk 2, the light reflected at the polarization beam splitter 7 is reflected at the mirror 8, and about 50% thereof passes through a beam splitter 10 and passes through a relay lens system formed of convex lenses 12 and 13 to become convergent light. Then the light enters a polarization beam splitter 17 as S-polarized light and almost 100% thereof is reflected, and focused inside the recording layer of the disk 2 by the objective lens 18. The light focused inside the recording layer of the disk 2 is reflected at a reflective layer of the disk 2, and passes through the objective lens 18 in an opposite direction. Then, the light enters the polarization beam splitter 17 as P-polarized light and almost 100% thereof passes through the beam splitter 17, is reflected at an interference filter 16, and passes through a relay lens system formed of convex lenses 15 and 14 in an opposite direction. About 50% thereof is reflected at a beam splitter 11, and astigmatism is given by an anamorphic lens system formed of a convex lens 21 and a cylindrical lens 22, and is focused on the light receiving section of the photodetector 23.

On the other hand, the light passing through the polarization beam splitter 7 passes through the shutter 9 which is a beam blocking unit. About 50% thereof passes through the beam splitter 11 and passes through the relay lens system formed of the convex lenses 14 and 15 so as to become divergent light, which is reflected at the interference filter 16 and enters the polarization beam splitter 17 as P-polarized light and almost 100% thereof passes through the polarization beam splitter 17 and is focused inside the recording layer of the disk 2 by the objective lens 18.

The photodetector 23 is provided between two focal lines formed by the anamorphic lens system formed of the convex lens 21 and the cylindrical lens 22, and has light receiving sections which are segmented into four by a parting line corresponding to the radial direction of the disk 2 and a parting line corresponding to the tangential direction of the disk 2. Based on a voltage signal output from each of the light receiving sections, a displacement of the focal point of the light passing through the polarization beam splitter 7 relative to the focal point of light reflected at the polarization beam splitter 7 inside the recording layer of the disk 2 is detected. A thickness-direction displacement signal, which is a focal point displacement in the thickness direction of the disk 2, is detected by a well-known astigmatism method, and a radial-direction displacement signal, which is a focal point displacement in the radial direction of the disk 2, is detected by a well-known radial push-pull method, and a tangential direction displacement signal, which is a focal point displacement in the tangential direction of the disk 2, is detected by a well-known tangential push-pull method.

In contrast, when information is reproduced from the disk 2, although the light reflected at the polarization beam splitter 7 is focused inside the recording layer of the disk 2, the light passing through the polarization beam splitter 7 is blocked at the shutter 9 and does not travel to the disk 2. The light focused inside the recording layer of the disk 2 is reflected at the recording layer of the disk 2 and passes through the objective lens 18 in an opposite direction, and enters the polarization beam splitter 17 as S-polarized light and almost 100% thereof is reflected. Then, the light passes through the relay lens system formed of the convex lenses 13 and 12 in an opposite direction, and about 50% thereof is reflected at the beam splitter 10 and is focused on the light receiving section of the photodetector 20 by the convex lens 19.

The semiconductor laser 24 outputs light having a wavelength of 650 nm. The light output from the semiconductor layer 24 passes through the convex lens 25 and is converted from the divergent light to parallel light. About 50% thereof passes through a beam splitter 26, passes through the interference filter 16, passes through the polarization beam splitter 17, and is focused on the reflective layer of the disk 2 by the objective lens 18. The light focused on the reflective layer of the disk 2 is reflected at the reflective layer of the disk 2, and the light passes through the objective lens 18 in an opposite direction, passes through the polarization beam splitter 17, and passes through the interference filter 16. About 50% thereof is reflected at the beam splitter 16, reflected at the mirror 27, and then astigmatism is given by an anamorphic lens system formed of a convex lens 28 and a cylindrical lens 29 and the light is focused on the light receiving section of the photodetector 30.

The photodetector 30 is provided between two focal lines formed by the anamorphic lens system formed of the convex lens 28 and the cylindrical lens 29, and has light receiving sections which are segmented into four by a parting line corresponding to the radial direction of the disk 2 and by a parting line corresponding to the tangential direction of the disk 2. In the reflective layer of the disk 2, a groove parallel to the tangential direction is formed. Based on a voltage signal output from each of the light receiving sections, displacement of the focal point of light output from the semiconductor layer 24 relative to the groove formed in the reflective layer of the disk 2 is detected. A focus error signal which is a focal point displacement in the thickness direction of the disk 2 is detected by a well-known astigmatism method, and a track error signal which is a focal point displacement in the radial direction of the disk 2 is detected by a well-known radial push-pull method.

FIGS. 2 to 4 are optical path diagrams showing incident beams and reflected beams with respect to the optical disk in FIG. 1. Hereinafter, description will be given based on FIGS. 1 to 4.

The disk 2 is configured such that a recording layer 33, a quarter wavelength plate layer 34, and a reflective layer 35 are sandwiched between substrates 31 and 32 in this order. Light enters from the side of the recording layer 33 through the substrate 31. The material of the substrates 31 and 32 may be glass, plastic, or the like. The material of the recording layer 33 may be photopolymer. The material of the quarter wavelength plate layer 34 may be a liquid crystal polymeric material oriented in an in-plane direction, a structure birefringent material in which cyclical grooves are formed in the in-plane direction, a photonic crystal material in which cyclical grooves are formed in the in-plane direction and a layer of low refractive index and a layer of high refractive index are alternately laminated thereon, or the like. The material of the reflective layer 35 may be aluminum, silver, or the like. FIGS. 2 and 3 show optical paths of incident beams and reflected beams when information is recorded on the disk 2. An incident beam 37 in FIG. 2 and an incident beam 39 in FIG. 3 respectively correspond to the light reflected at the polarization beam splitter 7 (first beam) and light passing through the polarization beam splitter 7 (second beam) in FIG. 1. On the other hand, FIG. 4 shows optical paths of an incident beam and a reflected beam when information is reproduced from the disk 2. An incident beam 41 in FIG. 4 corresponds to the light reflected at the polarization beam splitter 7 (first beam) in FIG. 1.

In FIG. 2, the incident beam 37 enters the objective lens 18 as convergent light in which the polarization direction thereof is at right angles to the sheet, and is focused on the way to the side of the reflective layer 35 within the recording layer 33. This light passes through the quarter wavelength plate layer 34 and is converted from linear polarized light in which the polarization direction is at right angles to the sheet to circular polarized light, and is reflected at the reflective layer 35 to thereby become the reflected beam 38, and passes through the quarter wavelength plate layer 34 so that it is converted from the circular polarized light to a linear polarized light in which the polarization direction is parallel to the sheet, passes through the recording layer 33, and is output from the objective lens 18 as convergent light in which the polarization direction thereof is parallel to the sheet. On the other hand, in FIG. 3, the incident beam 39 enters the objective lens 18 as divergent light in which the polarization direction thereof is parallel to the sheet, passes through the recording layer 33, passes through the quarter wavelength plate layer 34 so that it is converted from linear polarized light in which the polarization direction is parallel to the sheet to a circular polarized light, and is reflected at the reflective layer 35 to thereby become the reflected beam 40, and passes through the quarter wavelength plate layer 34 and is converted from circular polarized light to linear polarized light in which the polarization direction thereof is at right angles to the sheet, and is focused on the way to the side opposite to the reflective layer 35 within the recording layer 33. This light is output from the objective lens 18 as divergent light in which the polarization direction thereof is at right angles to the sheet. The incident beam 37 and the reflected beam 40 are focused on the same position in the recording layer 33 and interfered with each other, whereby a minute diffraction grating is formed near the focal point.

On the other hand, in FIG. 4, the incident beam 41 enters the objective lens 18 as convergent light in which the polarization direction thereof is at right angles to the sheet, and is focused on the above-described diffraction grating 36 on the way to the side of the reflective layer 35 within the recording layer 33. This light is reflected at the diffraction grating 36 to thereby become a reflected beam 42, and is output from the objective lens 18 as divergent light in which the polarization direction thereof is at right angles to the sheet. The reflected beam 42 is received by the photodetector 20 in FIG. 1. In this case, the diffraction grating 36 corresponds to a recording mark. By moving the position of the focal point of the incident beam 37 and the reflected beam 40 in a thickness direction of the recording layer 33 to thereby form a plurality of diffraction gratings not only in the in-plane direction of the recording layer 33 but also in the thickness direction thereof, three-dimensional recording and reproducing can be performed.

In the exemplary embodiment, as the incident beam 37 and the reflected beam 40 are interfered with each other because the polarization directions thereof are the same in the recording layer 33, the diffraction grating 36 is formed. As the incident beam 37 and the reflected beam 40 are focused on the same position in the recording layer 33, the intensity per unit area of the incident beam 37 and the reflected beam 40 is high near the focal point. As such, diffraction efficiency near the focal point of the diffraction grating 36 is high.

Besides the diffraction grating 36, as the incident beam 39 and the reflected beam 38 are interfered with each other because the polarization directions are the same in the recording layer 33, a diffraction grating is also formed. However, as the incident beam 39 and the reflected beam 38 are not focused inside the recording layer 33, the intensity per unit area of the incident beam 39 and the reflected beam 38 is low. As such, diffraction efficiency of the diffraction grating formed by interference between the incident beam 39 and the reflected beam 38 is very low. Further, as the polarization directions of the incident beam 37 and the reflected beam 38 are orthogonal to each other within the recording layer 33, they do not interfere with each other, and as the polarization directions of the incident beam 39 and the reflected beam 40 are orthogonal each other within the recording layer 33, they do not interfere with each other, and as the polarization directions of the incident beams 37 and 39 are orthogonal to each other within the recording layer 33, they do not interfere with each other, and as the polarization directions of the reflected beams 38 and 40 are orthogonal to each other within the recording layer 33, they do not interfere with each other. As such, no diffraction grating is formed by those beams.

This means that besides the diffraction grating 36 with high diffraction efficiency, no diffraction grating, in which diffraction efficiency is not so low, is formed in an overlapping manner near the focal point of the incident beam 37 and the reflected beam 40. As there is no diffraction grating not contributing to readout of information as described above, diffraction efficiency of the diffraction grating 36 contributing to readout of information will not be lowered, so that a high-quality readout signal can be obtained.

In the exemplary embodiment, the shutter 9 is provided on the optical path of light passing through the polarization beam splitter 7 in FIG. 1. When information is reproduced from the disk 2, the light passing through the polarization beam splitter 7 is blocked by the shutter 9. On the other hand, it is also acceptable that the shutter 9 is provided on the optical path of light reflected at the polarization beam splitter 7 in FIG. 1, and when information is reproduced from the disk 2, the light reflected at the polarization beam splitter 7 can be blocked by the shutter 9. In that case, the convex lens 19 and the photodetector 20 are provided on the optical path of light reflected at the beam splitter 11, and the convex lens 21, the cylindrical lens 22, and the photodetector 23 are provided on the optical path of light reflected at the beam splitter 10.

Further, in the exemplary embodiment, the polarization beam splitter 7 in FIG. 1 works as both the beam generation unit and the polarization setting unit. Alternatively, the beam generation unit and the polarization setting unit may be provided separately. For example, it is acceptable that the polarization beam splitter 7 is replaced with a beam splitter, and that a half wavelength plate is provided on the optical path of light reflected by the beam splitter or light passing through the beam splitter. If there is no half wavelength plate, the light reflected at the beam splitter and the light passing through the beam splitter have the same polarization directions. However, if there is a half wavelength plate, as one light passes through the half wavelength plate and the polarization direction is turned 90°, the polarization directions of the light reflected at the beam splitter and the light passing through the beam splitter are orthogonal to each other. In that case, the beam splitter corresponds to the beam generation unit, and the half wavelength plate corresponds to the polarization setting unit.

Further, in the exemplary embodiment, the polarization beam splitter 7 in FIG. 1 corresponds to the beam generation unit, and the shutter 9 corresponds to the beam blocking means. Alternatively, it is possible to provide a unit working as both the beam generation unit and the beam blocking unit. For example, it is acceptable to allow the half wavelength plate 6 to rotate about the optical axis of the incident light, and remove the shutter 9. When information is recorded on the disk 2, the half wavelength plate 6 is rotated such that the polarization direction of the light passing through the half wavelength plate 6 becomes 45° relative to the sheet, whereby light reflected at the polarization beam splitter 7 and light passing through the polarization beam splitter 7 are generated. In contrast, when information is reproduced from the disk 2, the half wavelength plate 6 is rotated such that the polarization direction of the light passing through the half wavelength plate 6 becomes perpendicular to the sheet, whereby only light reflected at the polarization beam splitter 7 is generated. In that case, the polarization beam splitter 7 corresponds to a unit working as both the beam generation unit and the beam blocking unit.

FIG. 5 is a block diagram showing an exemplary embodiment of an optical information recording/reproducing device according to the present invention. Hereinafter, description will be given based on FIGS. 1 and 5.

In an optical information recording/reproducing device 100 of the exemplary embodiment, an optical head 1 is the first exemplary embodiment of the optical head device according to the present invention shown in FIG. 1. The optical head 1 is mounted on a positioner 43, and the disk 2 is mounted on a spindle 44. All circuits from a modulation circuit 46 to a spindle drive circuit 61 are controlled by a controller 45.

The modulation circuit 46 modulates a signal input from the outside as record data when information is recorded on the disk 2, in accordance with modulation rules. A record signal generation circuit 47 generates a record signal for driving a laser 3 in the optical head 1, based on the signal modulated by the modulation circuit 46. When information is recorded on the disk 2, a laser drive circuit 48 drives the laser 3 by supplying a current corresponding to the record signal to the laser 3, based on the record signal generated by the record signal generation circuit 47. On the other hand, when information is reproduced from the disk 2, the laser drive circuit 48 drives the laser 3 by supplying a constant current to the laser 3 so as to make the power of the output light from the laser 3 constant.

When information is reproduced from the disk 2, the amplifier circuit 49 amplifies a voltage signal output from the light receiving section of a photodetector 20 within the optical head 1. A readout signal processing circuit 50 performs generation, waveform equalization, and binarization of a readout signal which is a mark/space signal recorded on the disk 2, based on the voltage signal amplified by the amplifier circuit 49. A demodulation circuit 51 demodulates the signal binarized by the readout signal processing circuit 50 in accordance with demodulation rules, and outputs it to the outside as readout data.

A shutter drive circuit 52, which is a beam block driving unit, does not block light passing through the polarization beam splitter 7 within the optical head 1 when information is recorded on the disk 2, and when information is reproduced from the disk 2, drives a shutter 9 in the optical head 1 by a motor, not shown, so as to block light passing through the polarization beam splitter 7 within the optical head 1.

A semiconductor layer drive circuit 53 drives a semiconductor laser 24 by supplying a constant current to the semiconductor laser 24 so as to make the power of output light from the semiconductor layer 24 in the optical head 1 constant, when information is recorded on or reproduced from the disk 2.

When information is recorded on the disk 2 or reproduced from the disk 2, the amplifier circuit 54 amplifies a voltage signal output from each light receiving section of the photodetector 30 in the optical head 1. An error signal generation circuit 55 generates a focus error signal and a track error signal for driving the objective lens 18 in the optical head 1, based on the voltage signal amplified by the amplifier circuit 54. An objective lens drive circuit 56 supplies a current corresponding to the focus error signal and the track error signal to a biaxial actuator of electromagnetic drive type, not shown, based on the focus error signal and the track error signal generated by the error signal generation circuit 55 to thereby drive the objective lens 18 in a thickness direction and in a radial direction of the disk 2.

The amplifier circuit 57 amplifies a voltage signal output from each light receiving section of the photodetector 23 in the optical head 1, when information is recorded on the disk 2. A displacement signal generation circuit 58 generates a thickness direction displacement signal, a radial direction displacement signal, and a tangent direction displacement signal, for driving a convex lend 14 or a convex lens 15 constituting a relay lens system within the optical head 1, based on the voltage signal amplified by the amplifier circuit 57. A relay lens drive circuit 59 supplies a current corresponding to the amount of movement to a uniaxial actuator of electromagnetic drive type, not shown, for moving the position of the focal point of light reflected at the polarization beam splitter 7 in the optical head 1 in a thickness direction of the disk 2, inside the recording layer of the disk 2, when information is recorded on or reproduced from the disk 2, to thereby drives a convex lens 12 or a convex lens 13 constituting a relay lens system in the optical head 1 in a direction corresponding to the thickness direction of the disk 2. When information is recorded on the disk 2, the relay lens drive circuit 59 also supplies a current corresponding to the thickness direction displacement signal, the radial direction displacement signal, and the tangent direction displacement signal, to a triaxial actuator of electromagnetic drive type, not shown, based on the thickness direction displacement signal, the radial direction displacement signal, and the tangent direction displacement signal generated by the displacement signal generation circuit 58, to thereby move the convex lens 14 or the convex lens 15 constituting the relay lens system in the optical head 1 in a direction corresponding to the thickness direction, the radial direction and the tangent direction of the disk 2.

A positioner control circuit 60 moves the positioner 43, on which the optical head 1 is mounted, in the radial direction of the disk 2 by a motor not shown, and a spindle control circuit 61 rotates the spindle 44, on which the disk 2 is mounted, by a motor not shown.

According to the optical information recording/reproducing device 100 of the exemplary embodiment, as the device is provided with the optical head 1 and the like, a high-quality readout signal can be obtained.

FIG. 6 is an optical path diagram showing a second exemplary embodiment of an optical head device according to the present invention. FIGS. 7 to 9 are optical path diagrams showing incident beams and reflected beams with respect to the optical disk in FIG. 6. Hereinafter, description will be given based on these drawings. However, the same components as those in FIGS. 1 to 4 are denoted by the same reference numerals and the description thereof is not repeated.

In an optical head 1′ of the exemplary embodiment, a quarter wavelength plate 101 is provided between a polarization beam splitter 17 and an objective lens 18. Corresponding to them, a convex lens 19 and a photodetector 20 are provided on the optical path of light reflected at the beam splitter 11, and a convex lens 21, a cylindrical lens 22, and a photodetector 23 are provided on the optical path of light reflected at the beam splitter 10. The polarization beam splitter 7 corresponds to the beam generation unit, and the polarization beam splitter 7 and the quarter wavelength plate 101 correspond to the polarization setting unit.

Each of incident beams 37, 39, and 41 and reflected beam 38, 40, and 42, shown in FIGS. 2 to 4, is linear polarized light. On the other hand, with the quarter wavelength plate 101 being provided between the polarization beam splitter 17 and the objective lens 18, each of incident beams 37′, 39′, and 41′ and reflected beams 38′, 40′, and 42′ can be circular polarized light. For example, the incident beam 37′ becomes right-handed circular polarized light, the incident beam 39′ becomes left-handed circular polarized light, the incident beam 41′ becomes right-handed circular polarized light, the reflected beam 38′ becomes left-handed circular polarized light, the reflected beam 40′ becomes right-handed circular polarized light, and the reflected beam 42′ becomes right-handed circular polarized light.

According to the optical head 1′ of the exemplary embodiment, as a diffraction grating is not formed between circular polarized light of different rotating directions inside the recording layer 33 of the disk 2, the same operations and effects as those of the optical head 1 of FIG. 1 can be achieved.

An optical recording medium according to another exemplary embodiment of the invention may include a recording layer and a reflective layer, and may be configured such that a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer, that is, a diffraction grating is formed in the recording layer by interference between the first beam which passes through the recording layer and travels to the reflective layer and the second beam which is reflected at the reflective layer and passes through the recording layer. The optical recording medium according to another exemplary embodiment of the invention may be configured as to include a quarter wavelength plate layer acting as a quarter wavelength plate with respect to the first beam and the second beam, between the recording layer and the reflective layer.

The first beam L1 is split into an incident beam L1i passing through the recording layer and traveling to the reflective layer, and a reflected beam L1o reflected at the reflective layer and passing through the recording layer. Similarly, the second beam L2 is split into an incident beam L2i and a reflected beam L2o. In a conventional optical recording medium, a diffraction grating is formed in the recording layer using interference between the incident beam L1i and the reflected beam L2o. If respective beams are shown only by reference signs, in addition to the combination of L1i-L2o, there are combinations of L1i-L1o, L1i-L2i, L1o-L2i, L1o-L2o, and L2i-L2o, with which diffraction gratings are also formed in the recording layer.

In contrast, an optical recording medium according to another exemplary embodiment of the invention is configured such that a quarter wavelength plate is inserted between the reflective layer and the recording layer, in which L1i is assumed to be an S wave and L2i is assumed to be a P wave. If these waves are indicated as L1iS and L2iP, the combinations described above become L1iS-L1oP, L1iS-L2iP, L1oP-L2iP, L1oP-L2oS, and L2iP-L2oS, besides L1iS-L2oS, with the action of quarter wavelength plate layer. In the combinations of L1iS-L1oP, L1iS-L2iP, L1oP-L2oS, and L2iP-L2oS, as the polarization directions are orthogonal to each other, no diffraction grating is formed. Further, in the case of L1oP-L2iP, although the polarization directions thereof are coincide with each other, as it is a combination before or after the combination of L1iS-L2oS generates a diffraction grating, the intensity of light is low. As such, the diffraction grating thereof can be disregarded. Accordingly, as no diffraction grating not contributing to readout of information is formed in the recording layer of the optical recording medium, only a diffraction grating generated by the combination of L1iS-L2oS is formed. Thereby, a high-quality readout signal is obtained.

An optical head device according to another exemplary embodiment of the invention is for use of the optical recording medium described above. The optical head device according to another exemplary embodiment of the invention may be configured as to include a beam generation unit which generates the first beam and the second beam, a lens system which focuses the first beam and the second beam on the same position in the recording layer, and a polarization setting unit which differentiates the polarization states of the first beam and the second beam entering the optical recording medium.

The first beam and the second beam generated by the beam generation unit are focused in the recording layer of the optical recording medium by the lens system. Then, in the optical recording medium, a diffraction grating is formed in the recording layer by interference between the first beam passing through the recording layer and traveling to the reflective layer and the second beam reflected at the reflective layer and passing through the recording layer. In this case, a quarter wavelength plate layer is provided between the recording layer and the reflective layer, and the polarization states of the first beam and the second beam entering the optical recording medium differ from each other by the polarization setting unit. Accordingly, as a diffraction grating is generated only by a combination of an incident beam of the first beam and a reflected beam of the second beam as described above, a high-quality readout signal can be obtained.

The polarization setting unit may cause the first beam and the second beam to be linear polarized light such that polarization directions thereof are orthogonal to each other, or cause the first beam and the second beam to be circular polarized light in which the rotating directions thereof are opposite to each other. Further, the beam generation unit and the polarization setting unit may include a polarization beam splitter which reflects and transmits an incident beam (not-polarized beam), or may include a polarization beam splitter which reflects and transmits an incident beam (not-polarized beam) and a quarter wavelength plate which transmits light passing through the polarization beam splitter and light reflected at the polarization beam splitter. In the case of using the polarization beam splitter, the both units can be realized by a simple configuration.

Further, an optical head device according to another exemplary embodiment of the invention may include, in addition to the above-described configurations, a beam blocking unit capable of switching whether or not to block one of the first beam and the second beam entering the optical recording medium; and a photodetector which receives reflected light from the diffraction grating by another one of the first beam and the second beam which was not blocked by the beam blocking unit. If the beam blocking unit does not block the first and the second beams, those beams reach the optical recording medium and generates a diffraction grating, whereby information can be recorded. In contrast, if the beam blocking unit blocks one of the first and the second beams, only the other beam reaches the optical recording medium and reflected at the diffraction grating, whereby information can be reproduced.

An optical information recording/reproducing device according to another exemplary embodiment of the invention may be configured to include the optical head device described above and a beam block driving unit. The beam block driving unit drives the beam blocking unit such that the beam blocking unit does not block the first beam and the second beam when information is recorded on the optical recording medium, and blocks one of the first beam and the second beam when information is reproduced from the optical recording medium. According to the optical information recording/reproducing device of another exemplary embodiment of the invention, as the optical information recording/reproducing device includes the optical head device and the like of another exemplary embodiment of the invention, a high-quality readout signal can be obtained.

An optical head device according to another exemplary embodiment of the invention may be configured for use of an optical recording medium and to include a light source, a beam generation unit, a lens system including an objective lens, a beam blocking unit, a photodetector, a polarization setting unit, and the like. The optical recording medium includes a recording layer and a reflective layer, in which light enters from the side of the recording layer, and a quarter wavelength plate layer, acting as a quarter wavelength plate with respect to transmitted light, is provided between the recording layer and the reflective layer. The lens system guides the first and the second beams to the optical recording medium, and focuses the first beam traveling inside the recording layer to the side of the reflective layer and the second beam passing through the recording layer, reflected at the reflective layer, and traveling inside the recording layer to the side opposite the reflective layer, on the same position in the recording layer. The beam blocking unit is a shutter for example, capable of switching whether or not to block one of the first beam and the second beam traveling from beam generation unit to the objective lens. The photodetector receives reflected light of the first beam or the second beam from the recording layer. The polarization setting unit causes the polarization states of the first beam and the second beam entering the optical recording medium to be orthogonal to each other.

An optical information recording/reproducing device according to another exemplary embodiment of the invention may be configured to include the above-described optical head device and a beam block driving unit. The beam block driving unit drives the beam blocking unit such that the beam blocking unit does not block the first beam and the second beam when information is recorded on the optical recording medium and blocks one of the first beam and the second beam when information is reproduced from the optical recording medium.

In an optical head device and an optical information recording/reproducing device according to another exemplary embodiment of the invention, an optical recording medium having a quarter wavelength plate layer provided between a recording layer and a reflective layer is used, and polarization states of a first beam and a second beam entering the optical recording medium are orthogonal to each other. In this case, as the polarization states of the first beam traveling inside the recording layer to the side of the reflective layer and the second beam traveling inside the recording layer to the side opposite to the reflective layer are the same, they interfere with each other, whereby a diffraction grating contributing to readout of information is formed near the focal point. On the other hand, in the first beam traveling inside the recording layer to the side of the reflective layer and the first beam traveling inside the recording layer to the side opposite the reflective layer, the second beam traveling inside the recording layer to the side of the reflective layer and the second beam traveling inside the recording layer to the side opposite to the reflective layer, the first beam traveling inside the recording layer to the side of the reflective layer and the second beam traveling inside the recording layer to the side of the reflective layer, and the first beam traveling inside the recording layer to the side opposite to the reflective layer and the second beam traveling inside the recording layer to the side opposite to the reflective layer, as the polarization states thereof are orthogonal to each other, they do not interfere with each other. As such, no diffraction grating not contributing readout of information is formed by those combinations. Accordingly, as the diffraction efficiency of the diffraction grating contributing to readout of information is not lowered, a high-quality readout signal can be obtained.

Although it is needless to say, the present invention is not limited to the respective embodiments described above. For example, although the optical recording medium has been described as an optical disk, it may be an optical recording medium in a card form.

While the present invention has been described with reference to the embodiments (and examples), the present invention is not limited to the above-described embodiments (and examples). Various changes in form and details of the present invention, which can be understood by those skilled in the art, may be made within the scope of the present invention.

This application is based upon and claims the benefit of priority from Japanese patent application No. 2007-116228, filed on Apr. 25, 2007, the disclosure of which is incorporated herein in its entirety by reference.

### BRIEF DESCRIPTION OF THE DRAWINGS

FIG. 1 is an optical path diagram showing a first exemplary embodiment of an optical head device according to the invention.

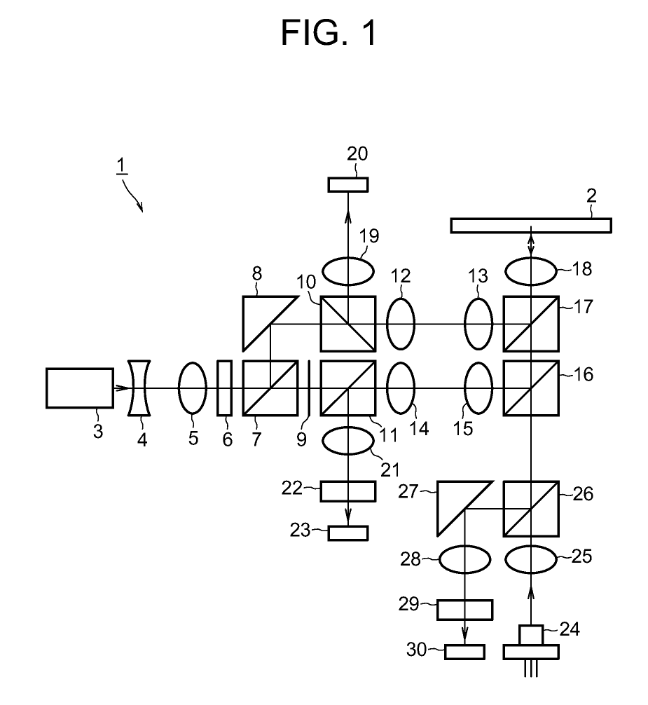

FIG. 2 is an optical path diagram (a) showing an incident beam and a reflected beam with respect to an optical disk of FIG. 1.

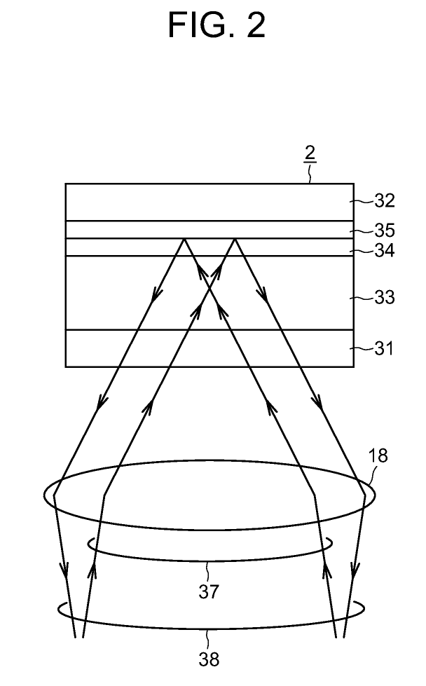

FIG. 3 is an optical path diagram (b) showing an incident beam and a reflected beam with respect to the optical disk of FIG. 1.

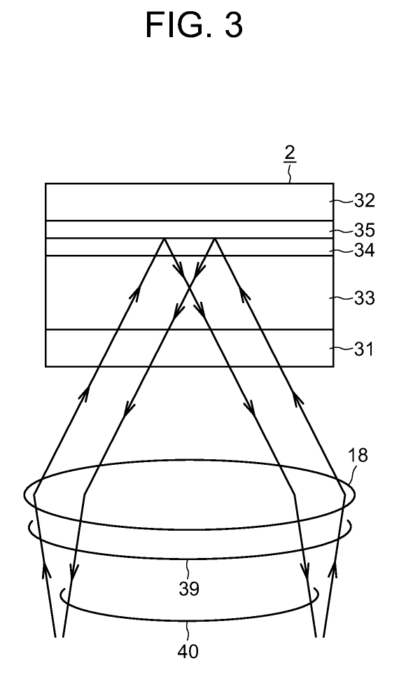

FIG. 4 is an optical path diagram (c) showing an incident beam and a reflected beam with respect to the optical disk of FIG. 1.

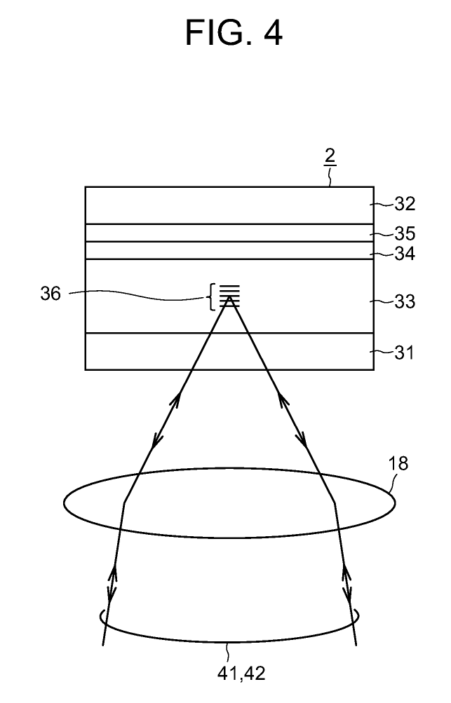

FIG. 5 is a block diagram showing an exemplary embodiment of an optical information recording/reproducing device according to the invention.

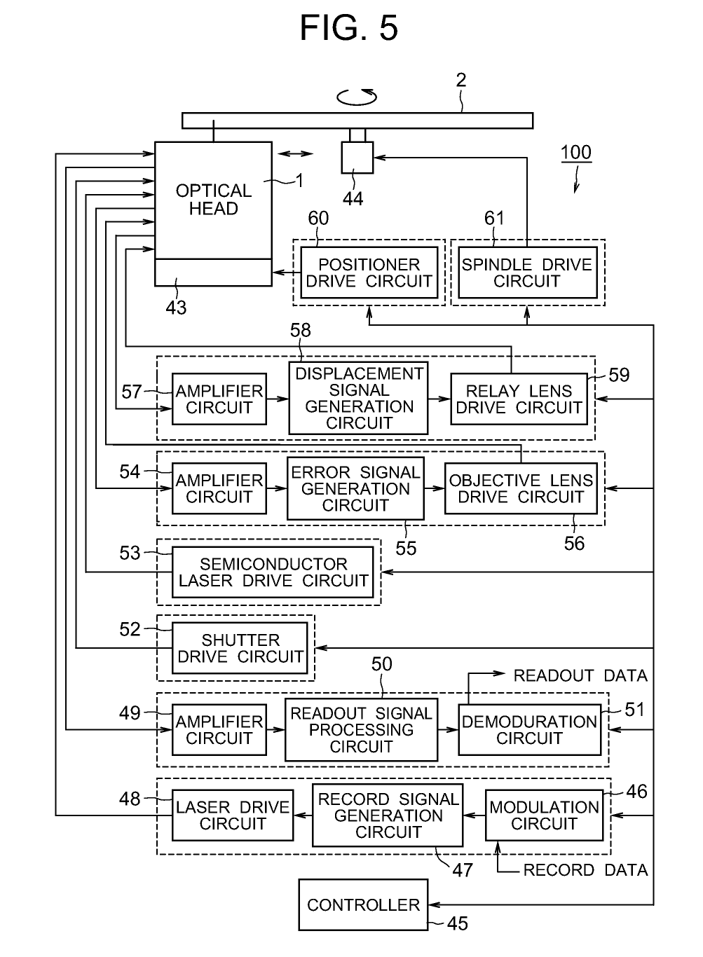

FIG. 6 is an optical path diagram showing a second exemplary embodiment of an optical head device according to the invention.

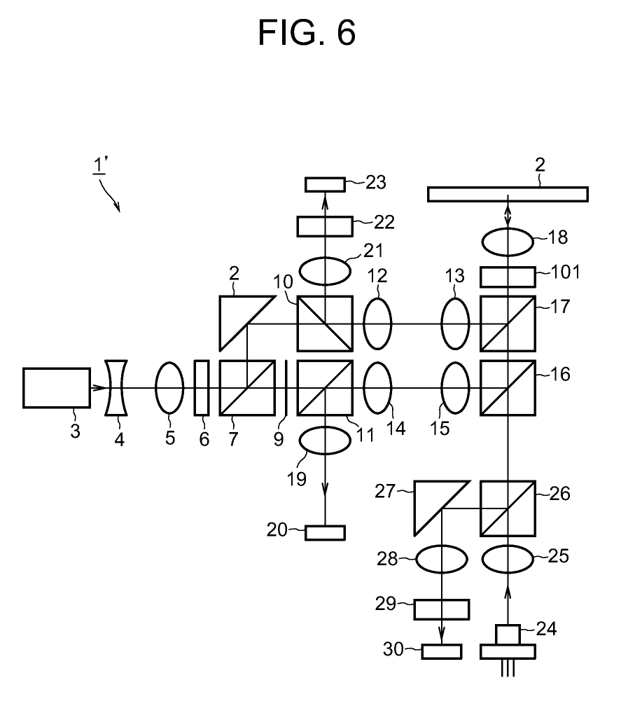

FIG. 7 is an optical path diagram (a) showing an incident beam and a reflected beam with respect to an optical disk of FIG. 6.

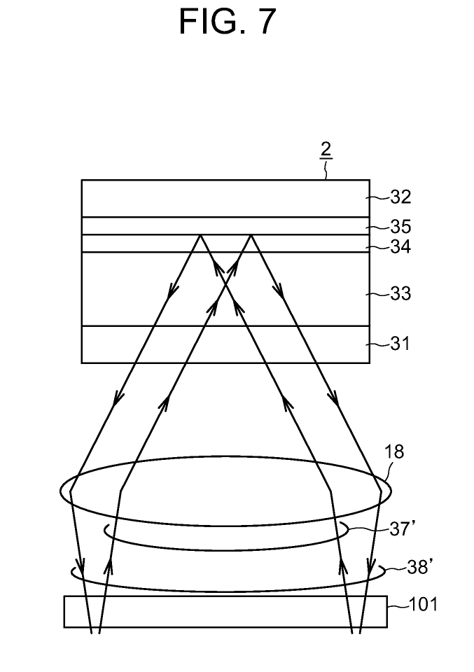

FIG. 8 is an optical path diagram (b) showing an incident beam and a reflected beam with respect to the optical disk of FIG. 6.

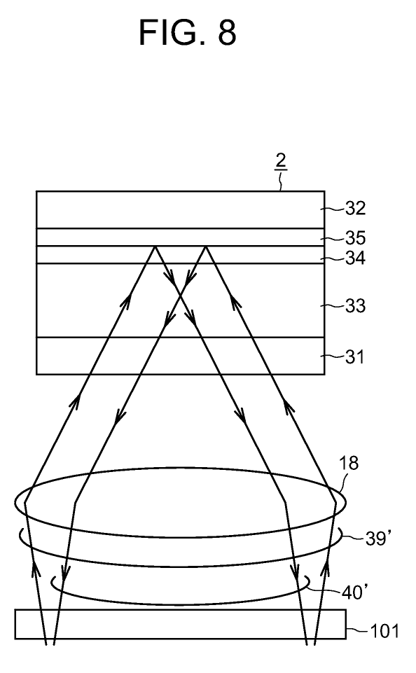

FIG. 9 is an optical path diagram (c) showing an incident beam and a reflected beam with respect to the optical disk of FIG. 6.

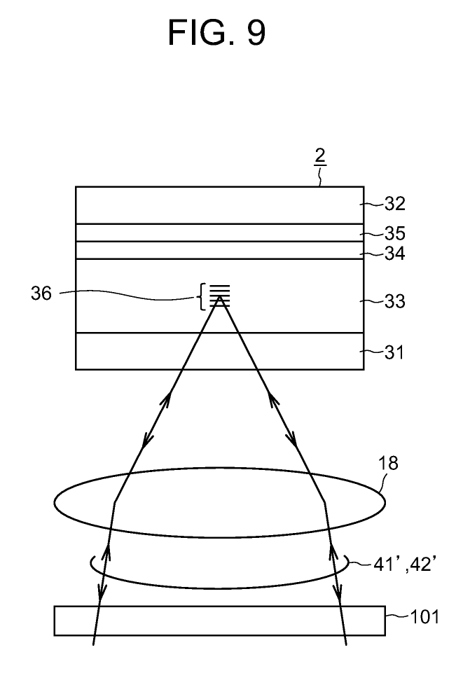

FIG. 10 is an optical path diagram showing a conventional optical head device.

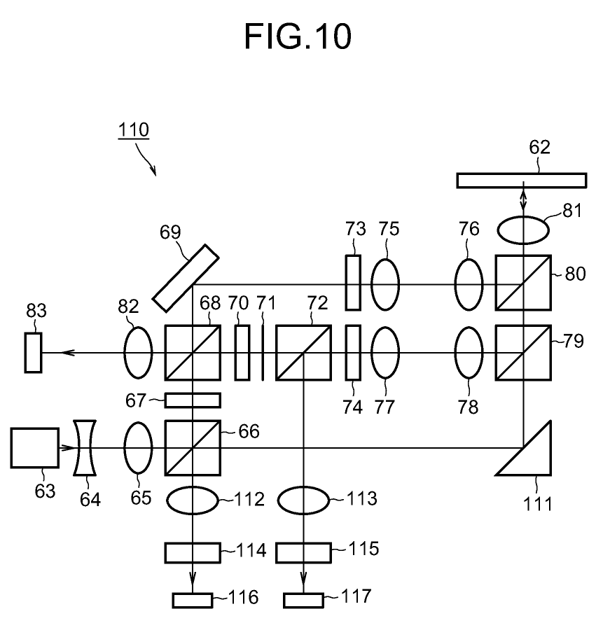

FIG. 11 is an optical path diagram (a) showing an incident beam and a reflected beam with respect to an optical disk of FIG. 10.

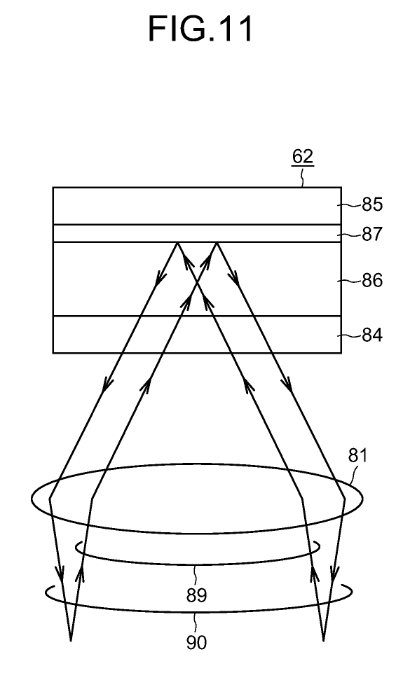

FIG. 12 is an optical path diagram (b) showing an incident beam and a reflected beam with respect to the optical disk of FIG. 10.

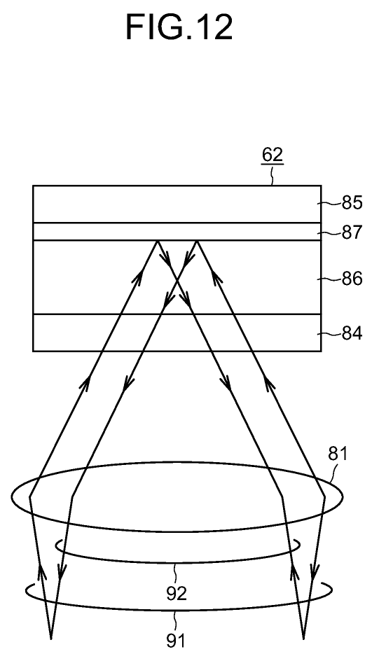

FIG. 13 is an optical path diagram (c) showing an incident beam and a reflected beam with respect to the optical disk of FIG. 10.

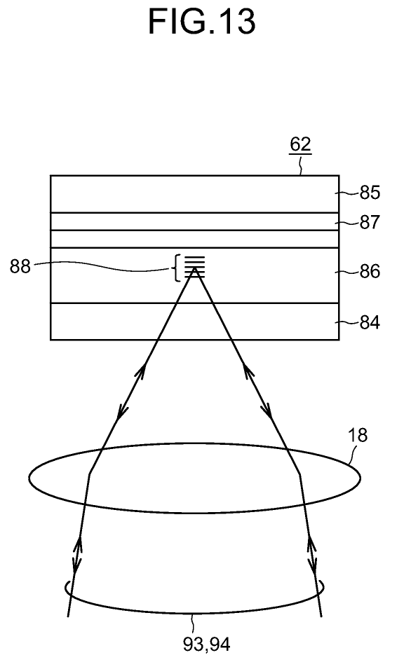

### REFERENCE NUMERALS

1, 1′ optical head (optical head device)

2 disk (optical disk, optical recording medium)

3 laser

4 concave lens

5 convex lens

6 half wavelength plate

7 polarization beam splitter (beam generation unit, polarization setting unit)

8 mirror

9 shutter (beam blocking unit)

10, 11 beam splitter

12-15 convex lens

16 interference filter

17 polarization beam splitter

18 objective lens

19 convex lens

20 photodetector

21 convex lens

22 cylindrical lens

23 photodetector

24 semiconductor laser

25 convex lens

26 beam splitter

27 mirror

28 convex lens

29 cylindrical lens

30 photodetector

31, 32 substrate

33 recording layer

34 quarter wavelength plate layer

35 reflective layer

36 diffraction grating

37, 37′ incident beam (first beam)

38, 38′ reflected beam (first beam)

39, 39′ incident beam (second beam)

40, 40′ reflected beam (second beam)

41, 41′ incident beam (first beam)

42, 42′ reflected beam (first beam)

43 positioner

44 spindle

45 controller

46 modulation circuit

47 record signal generation circuit

48 laser drive circuit

49 amplifier circuit

50 readout signal processing circuit

51 demodulation circuit

52 shutter drive circuit (beam block driving unit)

53 semiconductor laser drive circuit

54 amplifier circuit

55 error signal generation circuit

56 objective lens drive circuit

57 amplifier circuit

58 displacement signal generation circuit

59 relay lens drive circuit

60 positioner drive circuit

61 spindle drive circuit

100 optical information recording/reproducing device

101 quarter wavelength plate (polarization setting unit)

1-9. (canceled)

10. An optical recording medium having a recording layer and a reflective layer, in which a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer, the optical recording medium comprising:
a quarter wavelength plate layer provided between the recording layer and the reflective layer and acting as a quarter wavelength plate with respect to the first beam and the second beam.

11. The optical recording medium as claimed in claim 10, wherein the optical recording medium is an optical disk.

12. An optical head device for use of an optical recording medium, in which the optical recoding medium includes a recording layer and a reflective layer, and a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer, and the optical recording medium includes a quarter wavelength plate layer provided between the recording layer and the reflective layer and acting as a quarter wavelength plate with respect to the first beam and the second beam, the optical head device comprising:
a beam generation unit which generates the first beam and the second beam;
a lens system which focuses the first beam and the second beam on a same position in the recording layer; and
a polarization setting unit which differentiates the polarization states of the first beam and the second beam which enter the optical recording medium.

13. The optical head device as claimed in claim 12, wherein the polarization setting unit causes the first beam and the second beam to be linear polarized light in which polarization directions thereof are at orthogonal to each other.

14. The optical head device as claimed in claim 12, wherein the polarization setting unit causes the first beam and the second beam to be circular polarized light in which the rotating directions thereof are opposite to each other.

15. The optical head device as claimed in claim 13, wherein the beam generation unit and the polarization setting unit include a polarization beam splitter which reflects and transmits an incident beam.

16. The optical head device as claimed in claim 14, wherein the beam generation unit and the polarization setting unit include a polarization beam splitter which reflects and transmits an incident beam, and a quarter wavelength plate which transmits light passing through the polarization beam splitter and light reflected at the polarization beam splitter.

17. The optical head device as claimed in claim 12, further comprising:
a beam blocking unit capable of switching whether or not to block one of the first beam and the second beam entering the optical recording medium; and
a photodetector which receives reflected light from the diffraction grating by another one of the first beam and the second beam which was not blocked by the beam blocking unit.

18. An optical information recording/reproducing device comprising an optical head device for use of an optical recording medium and a beam block driving unit, wherein
the optical recording medium includes:
a recording layer and a reflective layer, in which a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer; and
a quarter wavelength plate layer provided between the recording layer and the reflective layer and acting as a quarter wavelength plate with respect to the first beam and the second beam,
the optical head device includes:
a beam generation unit which generates the first beam and the second beam;
a lens system which focuses the first beam and the second beam on a same position in the recording layer;
a polarization setting unit which differentiates polarization states of the first beam and the second beam entering the optical recording medium;
a beam blocking unit capable of switching whether or not to block one of the first beam and the second beam which enter the optical recording medium; and
a photodetector which receives reflected light from the diffraction grating by another one of the first beam and the second beam which was not blocked by the beam blocking unit, and
the beam block driving unit drives the beam blocking unit such that the beam blocking unit does not block the first beam and the second beam when information is recorded on the optical recording medium, and blocks one of the first beam and the second beam when information is reproduced from the optical recording medium.

19. An optical head device for use of an optical recording medium, in which the optical recoding medium includes a recording layer and a reflective layer, and a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer, and the optical recording medium includes a quarter wavelength plate layer provided between the recording layer and the reflective layer and acting as a quarter wavelength plate with respect to the first beam and the second beam, the optical head device comprising:
beam generation means for generating the first beam and the second beam;
lens means for focusing the first beam and the second beam on a same position in the recording layer; and
polarization setting means for differentiating the polarization states of the first beam and the second beam which enter the optical recording medium.

20. An optical information recording/reproducing device comprising an optical head device for use of an optical recording medium and a beam block driving unit, wherein
the optical recording medium includes:
a recording layer and a reflective layer, in which a diffraction grating is formed in the recording layer by interference between a first beam and a second beam, the first beam entering from a side of the recording layer and traveling inside the recording layer to a side of the reflective layer, and the second beam entering from the side of the recording layer, passing inside the recording layer, being reflected at the reflective layer, and traveling inside the recording layer to a side opposite to the reflective layer; and
a quarter wavelength plate layer provided between the recording layer and the reflective layer and acting as a quarter wavelength plate with respect to the first beam and the second beam,
the optical head device includes:
beam generation means for generating the first beam and the second beam;
lens means for focusing the first beam and the second beam on a same position in the recording layer;
polarization setting means for differentiating polarization states of the first beam and the second beam entering the optical recording medium;
beam blocking means for being capable of switching whether or not to block one of the first beam and the second beam which enter the optical recording medium; and
photodetecting means for receiving reflected light from the diffraction grating by another one of the first beam and the second beam which was not blocked by the beam blocking unit, and
the beam block driving unit drives the beam blocking means such that the beam blocking means does not block the first beam and the second beam when information is recorded on the optical recording medium, and blocks one of the first beam and the second beam when information is reproduced from the optical recording medium.

21. The optical head device as claimed in claim 13, further comprising:
a beam blocking unit capable of switching whether or not to block one of the first beam and the second beam entering the optical recording medium; and
a photodetector which receives reflected light from the diffraction grating by another one of the first beam and the second beam which was not blocked by the beam blocking unit.

22. The optical head device as claimed in claim 14, further comprising:
a beam blocking unit capable of switching whether or not to block one of the first beam and the second beam entering the optical recording medium; and
a photodetector which receives reflected light from the diffraction grating by another one of the first beam and the second beam which was not blocked by the beam blocking unit.

23. The optical head device as claimed in claim 15, further comprising:
a beam blocking unit capable of switching whether or not to block one of the first beam and the second beam entering the optical recording medium; and
a photodetector which receives reflected light from the diffraction grating by another one of the first beam and the second beam which was not blocked by the beam blocking unit.

24. The optical head device as claimed in claim 16, further comprising:
a beam blocking unit capable of switching whether or not to block one of the first beam and the second beam entering the optical recording medium; and
a photodetector which receives reflected light from the diffraction grating by another one of the first beam and the second beam which was not blocked by the beam blocking unit.
